(19) United States
(12) Patent Application Publication
(10) Pub. No.: US 2011/0093252 A1
(43) Pub. Date: Apr. 21, 2011

(54) METHOD OF ACCURATELY SIMULATING A TARGET MACHINE ON A SIMULATOR

(76) Inventors: Shi-Wu Lo, Min-Hsiung (TW); Sheng-Yu Lin, Min-Hsiung (TW); Yi Lee, Min-Hsiung (TW)

(21) Appl. No.: 12/580,338

(22) Filed: Oct. 16, 2009

(51) Int. Cl. G06F 9/455; G06G 7/62

(52) U.S. Cl. 703/20; 703/26

(57) ABSTRACT

A method of accurately simulating a target machine on a simulator, wherein, a mapping table is set up in a main program to record correspondence relations between target machine instructions and host machine instructions, and a signal handler is registered in a host machine for calling said mapping table. When an interrupt occurs while said simulator is performing simulation for a target program on the host machine, signal handler searches the mapping table to obtain or dynamically calculates to obtain host machine instruction corresponding to the next target machine instruction to be executed in target program; and replacing said host machine instruction with a return instruction, thus when executing said return instruction, the simulator will return to main program in checking said interrupt and proceeding with necessary proceedings required. Through the present invention, when said interrupt occurs, said simulator may return to main program in time for handling the interrupt.

### BACKGROUND OF THE INVENTION

1. Field of the Invention

The present invention relates to a technology of performing translations in a simulator, and in particular to a method of establishing a mapping table in a simulator specifying the corresponding relations between target machine instructions and host machine instructions, and of processing interrupt procedures while proceeding with translations.

2. The Prior Arts

Presently, simulators play an important and crucial role in the industry, since simulator is able to provide an easy environment and much more tools for debugging to shorten product development time required. Therefore, it is not only able to raise the facility in system software development, but it is also capable of increasing the stability of system software thus acquired.

Since simulator has become an indispensable tool or environment for the development of a system, so it is an important task as to how to guarantee the performance of simulator such that it is able to verify the program codes written by programmers, so that when interrupt or exception occurs, a simulator still can make correct presentation. For in an interpreting simulator, since it only executes instructions one at a time, therefore, when interrupt occurs it can handle this problem immediately.

In contrast, for a binary translation type simulator, since it performs translations utilizing a translation block as a unit, such that it must wait until all the codes in a translation block have been executed, it will then return to a main program to check if an interrupt has indeed occurred. If it does find an interrupt, then it will jump out of the main program and cease execution. Therefore, when an interrupt occurs, it is not able to handle the interrupt immediately, yet it has to wait till the end of execution of this translation block, then it will have the chance to handle the interrupt. However, this kind of behavior is not compatible with normal execution procedure, since once a nested interrupt occurs, the interrupts is not handled immediately but is handled consecutively; moreover, this kind of behavior will make program block into an atomic program block which are originally not atomic. Therefore, this kind of behavior tends to create errors in certain programs. For example, program codes that originally may create race conditions are caused not to create race conditions.

In view of the problems and shortcomings of the prior art, the present invention proposes a method of accurately simulating a target machine on a simulator, so as to solve the problem of the prior art.

### SUMMARY OF THE INVENTION

A major objective of the present invention is to provide a method of accurately simulating a target machine on a simulator, that is used to create a correspondence between target machine instructions and host machine instructions and present it with a mapping table; or it may utilize a binary translator to dynamically calculate and obtain correspondence between target machine instructions and host machine instructions, so that when an interrupt occurs, it may quickly find the host machine instruction for the next target machine instruction.

Another objective of the present invention is to provide a method of accurately simulating a target machine on a simulator, so that when an interrupt occurs, the host machine instruction corresponding to the next target machine instruction is converted into a return instruction, so as to realize the objective of returning immediately to the main program without having to finish executing an entire translation block.

In order to achieve the above mentioned objective, the present invention provides a method of accurately simulating a target machine on a simulator, wherein, a mapping table is first established in a main program to record the corresponding relations between target machine instructions and host machine instructions; or a translator is used to calculate the corresponding relations, and a signal handler registered in a host machine is used for calling the mapping table. As such, in case that an interrupt occurs when a simulator is simulating a target program on a host machine, the signal handler will search and obtain from the mapping table or calculate dynamically the host machine instruction corresponding to the next target machine instruction to be executed by a target program, and replace the host machine instruction with a return instruction, and when the signal handler executes the return instruction, it will return to the main program to check the interrupt and proceed with the necessary processing as required.

Further scope of the applicability of the present invention will become apparent from the detailed description given hereinafter. However, it should be understood that the detailed description and specific examples, while indicating preferred embodiments of the present invention, are given by way of illustration only, since various changes and modifications within the spirit and scope of the present invention will become apparent to those skilled in the art from this detailed description.

### BRIEF DESCRIPTION OF THE DRAWINGS

The related drawings in connection with the detailed description of the present invention to be made later are described briefly as follows, in which:

FIG. 1 is a flowchart of the steps of a method of accurately simulating a target machine on a simulator according to the present invention;

FIGS. 2 shows the program codes for setting up a mapping table for mapping target machine instructions to intermediate instructions;

FIG. 3 shows the program codes used for setting up a mapping table for mapping intermediate instructions to host machine instructions;

FIGS. 4 shows the program codes of the procedure to be processed by a signal handler; and

FIG. 5 shows the program codes of the latest instruction as searched and obtained by a signal handler.

### DETAILED DESCRIPTION OF THE PREFERRED EMBODIMENT

The purpose, construction, features, functions and advantages of the present invention can be appreciated and understood more thoroughly through the following detailed description with reference to the attached drawings.

In the present invention, a method of accurately simulating a target machine on a simulator is provided. In the prior art, the processing of timer interrupt is performed after the completion of executing an entire translation block. In the present invention, the interrupt processing is improved, so that any arbitrary interrupts of process execution can be handled immediately, namely, an interrupt can be handled while performing code translation. Therefore, it does not have to postpone interrupt handling until the completion of execution of an entire block translation, thus it will not affect the execution speed.

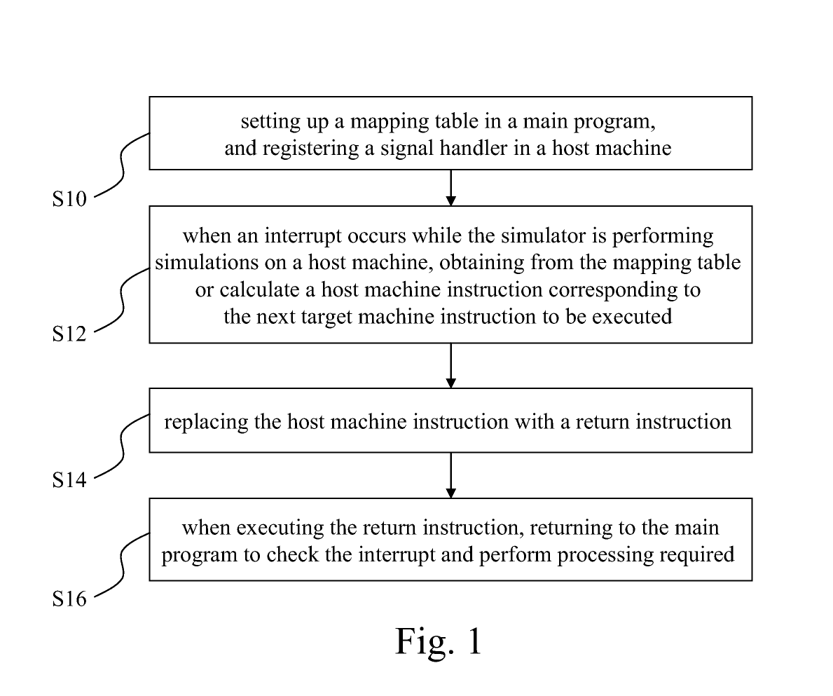

Refer to FIG. 1 for a flowchart of the steps of a method of accurately simulating a target machine on a simulator according to the present invention. As shown in FIG. 1, wherein, firstly, in step S10, a signal handler is registered in a host machine, and a mapping table is set up in a main program of the simulator to record a plurality of instructions, including the corresponding relations between the target machine instructions and host machine instructions, these corresponding relations can also be dynamically calculated and obtained through a binary translator; next, in step S12, when a simulator on a host machine is performing simulation for a target program, and in case that the host machine or simulator finds that the target machine produces an immediate reaction to an interrupt, namely, an interrupt occurs during an execution process, the simulator utilizes a signal handler to search and obtain from a mapping table a host machine instruction corresponding to a next target machine instruction to be executed in a target program, or the simulator utilizes the signal handler to calculate dynamically and obtain that host machine instruction; in step S14, replacing the host machine instruction with a return instruction. Therefore, when in step S16 the simulator executes this return instruction, the execution process of the simulator will return to the main program, in order to check the interrupt and proceed with the necessary processing as required.

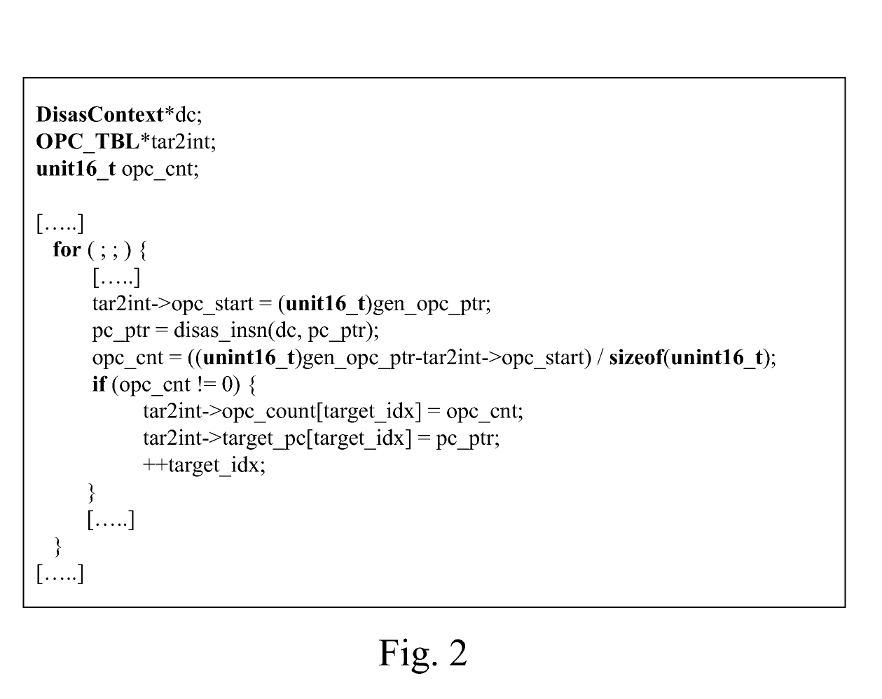

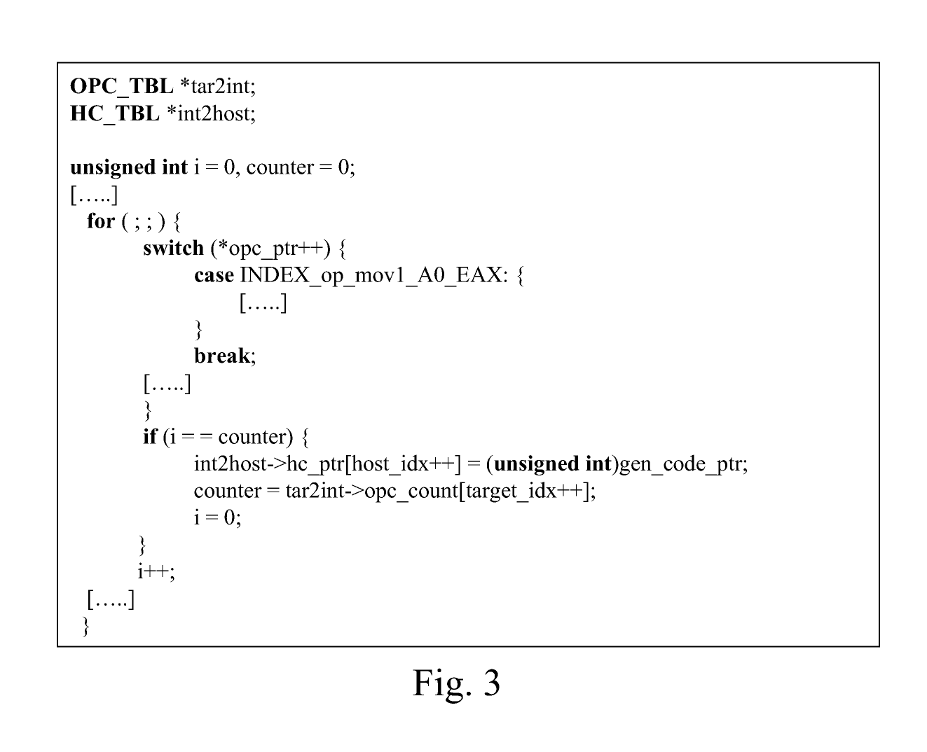

In the present invention, the mapping table includes two portions, and that are realized in the following steps: firstly, establishing a mapping table for mapping the target machine instructions to the intermediate instructions, and when the target machine instructions are translated into the intermediate instructions, recording how many intermediate instructions can be translated from the present target machine instruction and the next target machine instruction; and secondly, setting up a mapping table for mapping the intermediate instructions to the host machine instructions. In this respect, a QEMU simulator is taken as an example, refer to FIG. 2 for program codes used for setting up a mapping table for mapping target machine instructions to intermediate instructions, and refer to FIG. 3 for program codes used for setting up a mapping table for mapping intermediate instructions to host machine instructions, and also refer to the following table 1 for the data structure and name of variables contained therein.

TABLE 1

| data structure & | |
|---|---|
| name of variable | description of applications |
| unsigned int opc_count [ ] | recording how many immediate |
| | instructions are translated from each |
| | target machine instruction |
| unsigned int target_pc [ ] | recording the next target machine |
| | instruction to be executed |
| unint16_t opc_start | recording the address of the first |
| | immediate instruction |
| unsigned int hc_ptr [ ] | recording the starting address of the |
| | translated host machine instruction |
| | block corresponding to the target |
| | machine instruction |
| unsigned int counter | recording how many immediate |
| | instructions are translated from the |
| | target machine instruction |
| int has_signal | indicating there is an interrupt at |
| | present and is located in a translation |
| | block |
| unsigned int backup_op | copying a part of instruction op code |
| unsigned int closest_eip | the closest eip value |
| unsigned int MAP_IDX | index of target machine instruction |
| | the closest instruction |

Firstly, a signal_handler is registered in a QEMU simulator, and the function of this signal_handler is to search a mapping table mapping intermediate instructions to host machine instructions as set up during translation, in finding out the instruction block of the most adjacent host machine instruction, and replacing its first instruction with a return (RET) instruction, so that when the program executes this instruction, it will return to the main program of QEMU simulator to check the interrupt and handle the necessary processing as required.

As the QEMU simulator performs translation of the target machine instruction, a mapping table is established by using a cpu_gen_code ( )function, and this function is mainly composed of two parts, and that can be realized as follows: firstly, calling a gen_intermediate_code_internal ( )function, translating the target machine instruction in a target program into program codes of intermediate instructions, as shown in FIG. 2, this section of program codes is located in gen_intermediate_code_internal ( )function. Gen_opc_ptr is an index variable pointing to gen_opc_buf, storing the starting address of gen_opc_buf in an opc_start variable, hereby indicating recording the program code address of the first immediate instruction generated, then, disas_insn performs translation for the present target machine instruction, such that for each of the immediate instruction program code generated, in addition to storing the address of immediate instruction program code into gen_opc_buf, meanwhile, gen_opc_ptr is added by 1, then the return value is the next target machine instruction (next target eip) to be executed; subsequently, subtracting the starting address from the address pointed by the last gen_opc_ptr, thus obtaining the number of intermediate instructions that can be translated from a target machine instruction, as long as the number of the translated intermediate instructions is not equal to zero, then recording the number of intermediate instructions, and the address of the next target machine instruction.

Then, in order to realize the second portion of the cpu_gen_code ( ) function, refer to FIG. 3 for the program codes used for setting up a mapping table for mapping intermediate instructions to host machine instructions. Wherein, firstly, calling dyngen_code ( )function, for translating program codes of intermediate instruction into program codes of host machine instructions. Gen_code_ptr is the starting address of the translated host machine instructions after it is translated from the intermediate instructions, thus after each of the immediate instructions is translated, gen_code_ptr is increased. However, the mapping table is intended to record the first instruction of a host machine instruction block corresponding to the target machine instruction, therefore a counter is utilized to count the number of the immediate instructions, and the contents of the counter are the number of the immediate instructions corresponding to the target machine instructions. In case that the reply to ┌if┘ is true, then it represents the first instruction of the host machine instruction block corresponding to the target machine instructions at present, and then record its instruction address into hc_ptr, and fetch the immediate instruction number corresponding to this target machine instruction, and reset i to 0 and start the count again. A host_idx represents the host machine instruction block corresponding to the target machine instructions, and target_idx plus 1 represents the next target machine instruction.

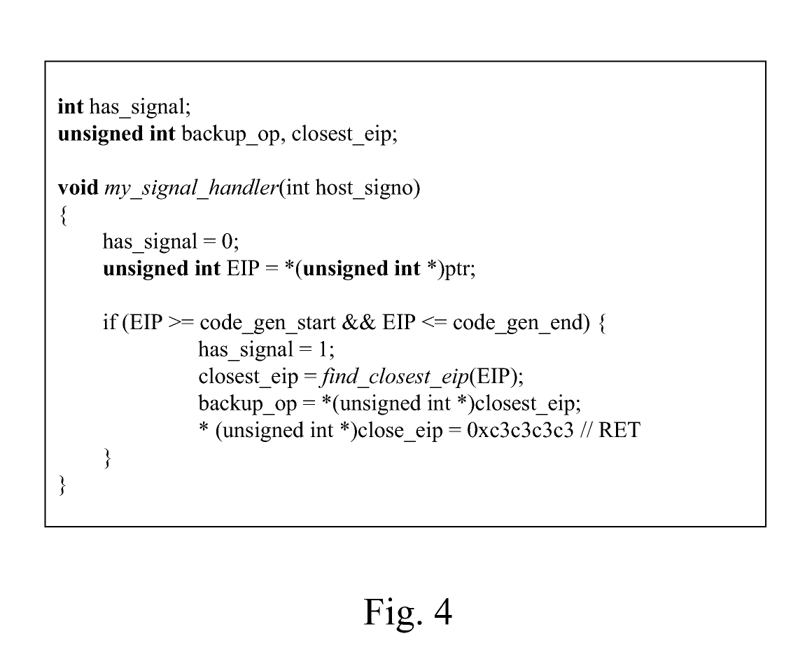

In a QEMU simulator, when the main program receives an interrupt signal sent by the host machine instruction, then it will first be transformed into a signal at the host machine instruction end to inform the main program. Subsequently, the main program will handle this signal through a signal_handler registered in advance, as shown in FIG. 4. The major tasks of the signal_handler are as follows:
(1) firstly, determining that the instruction causing the interrupt is in the translation block;
(2) if the answer is yes, setting the signal flag to 1;
(3) searching a mapping table, to find the target machine instruction that caused this interrupt, and sending back the host machine instruction corresponding to that target machine instruction;
(4) copying the host machine instruction to be replaced; and
(5) replacing this host machine instruction with a return instruction.

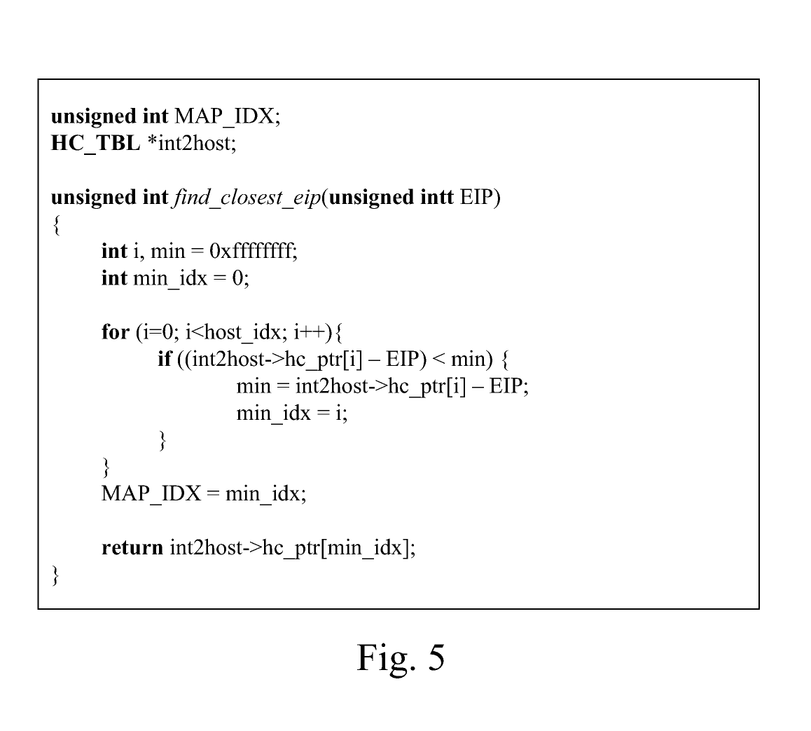

Refer to FIG. 5 for the program codes of the latest instruction as searched and obtained by a signal handler. As shown in FIG. 5, upon the return of the signal handler, it will continue to execute the translation task, until it reaches the return instruction previously replaced, then it will jump back to the main program of the QEMU. At this moment, it will first resume the host machine instruction just replaced to the original target machine instruction, and then execute it to see if an interrupt would occur. In case that an interrupt does occur, then save and store the target machine instruction originally intended to be executed, so that after finishing processing the interrupt it can return to the correct address for resuming the translation operation, then it will call a do_interrupt ( )function, but the do_interrupt ( )function will not handle the interrupt by itself, yet it will change the address of the next instruction to be executed (eip) to a starting address of an interrupt service routine (ISR), until the cpu_gen_code ( )function is called, then it will perform binary translation for the program code of the interrupt service routine (ISR), and finally, it will call gen-func to really execute the interrupt service routine (ISR).

Summing up the above, in the present invention, a method of accurately simulating a target machine on a simulator can be realized in the following steps: establishing in a simulator mapping tables for corresponding relations between target machine instructions and intermediate instructions, and intermediate instructions and host machine instructions respectively; and adding a mechanism for replacing a host machine instruction with a return instruction, such that when an interrupt occurs while performing translation in a simulator, it can be known from the mapping tables the host machine instruction corresponding to the next target machine instruction, hereby replacing the host machine instruction with a return instruction; therefore, the next instruction to be executed after an interrupt is a return instruction, thus the process will return to the main program of the simulator to proceed with interrupt processing. The method of accurately simulating a target machine on a simulator according to the present invention can be utilized to overcome the shortcomings of the simulator of the prior art that: in case that an interrupt occurs, instructions of an entire translation block have to be executed before the process can go back to the main program, thus being able to avoid errors that may happen to certain programs.

The above detailed description of the preferred embodiment is intended to describe more clearly the characteristics and spirit of the present invention. However, the preferred embodiments disclosed above are not intended to be any restrictions to the scope of the present invention. Conversely, its purpose is to include the various changes and equivalent arrangements which are within the scope of the appended claims.

What is claimed is:

1. A method of accurately simulating a target machine on a simulator, wherein, a mapping table is established in said simulator specifying corresponding relations between a plurality of target machine instructions and a plurality of host machine instructions, so as to process an interrupt real-time, comprising the following steps:
registering a signal handler by said simulator in a host machine;
establishing said mapping table is in a main program for recording said corresponding relations between said target machine instructions and said host machine instructions, or dynamically calculating said corresponding relations between said target machine instructions and said host machine instructions by using a binary translator;
when said simulator performs simulation of a target program on said host machine, and said host machine or said simulator finds that a target machine produces immediate reaction to an interrupt, then said simulator utilizes said signal handler to retrieve from said mapping tables or dynamically calculates said host machine instruction corresponding to said next target machine instruction to be executed in said target program; and
replacing said host machine instruction with a return instruction, and when executing said return instruction, an execution process of said simulator will return to said main program of said simulator, and it will check said interrupt in said main program to proceed with said processing as required.

2. The method of accurately simulating a target machine on a simulator as claimed in claim 1, wherein
when said target machine instructions are translated into said immediate instructions, a first mapping table is established for mapping said target machine instructions to said immediate instructions, so as to record how many immediate instructions are translated from said present target machine instruction and said next target machine instruction.

3. The method of accurately simulating a target machine on a simulator as claimed in claim 1, wherein
when said immediate instructions are translated into said host machine instructions, a second mapping table is established for mapping said intermediate instructions to said host machine instructions, so as to record a block starting address of said host machine instruction corresponding to said target machine instructions.

4. The method of accurately simulating a target machine on a simulator as claimed in claim 1, wherein
said signal handler determines that whether said interrupt occurred in a translation block that said main program is performing translation of codes, if an answer is affirmative, then searches said mapping table or calculates dynamically to find said interrupt occurred at which one of said target machine instructions, and replaces a next instruction of said target machine instruction with said return instruction for transferring control to said main function of said simulator.

5. The method of accurately simulating a target machine on a simulator as claimed in claim 4, wherein
said signal handler further copies said host machine instruction and replaces said host machine instruction with said return instruction.
